(19) United States
(12) Patent Application Publication
(10) Pub. No.: US 2015/0262507 A1
(43) Pub. Date: Sep. 17, 2015

(54) METHOD, SYSTEM, AND COMPUTER PROGRAM PRODUCT FOR NUTRITIONAL IMPROVEMENT

(71) Applicants: Alaina B. Hanlon, Boston, MA (US); Robert Jahreis, Branford, CT (US)

(72) Inventors: Alaina B. Hanlon, Boston, MA (US); Robert Jahreis, Branford, CT (US)

(73) Assignee: NuPlanit, Inc., Boston, MA (US)

(21) Appl. No.: 14/535,217

(22) Filed: Nov. 6, 2014

Related U.S. Application Data
(63) Continuation-in-part of application No. 13/554,672, filed on Jul. 20, 2012.
(60) Provisional application No. 61/900,443, filed on Nov. 6, 2013.

(51) Int. Cl. G09B 19/00

(52) U.S. Cl. CPC G09B 19/0092

(57) ABSTRACT

Disclosed are methods comprising: receiving data representing the physical location, movement, social environment, emotional state and nutritional behavior; comparing this data and nutritional behaviors throughout the day to goals for achieving a balance of macronutrients (food groups) and micronutrients, represented by a Nutrition Score; determining the positive and negative impact of physical and social environment on nutritional behaviors and emotional state; targeting messages, cues, tips and coping tactics based on acquired parameters to help change the individuals response to the environment and other factors, improve mood, reduce anxiety and improve nutritional behavior; and allowing for real-time connectivity to a support system. Also disclosed are methods where the acquired parameters are transmitted to health care professionals, such as dietitians, therapists, physicians, health coaches, through real-time connectivity to acquired parameters, health professionals can more effectively coordinate and target care.

### CROSS-REFERENCE TO RELATED APPLICATIONS

This application: (i) is a continuation-in-part of U.S. patent application Ser. No. 13/554,672, filed Jul. 20, 2012; and (ii) claims the benefit of U.S. Provisional Patent Application No. 61/900,443, filed Nov. 6, 2013, the entire contents of each of which are hereby incorporated by reference.

### BACKGROUND OF THE INVENTION

This provisional patent builds on the previous patent, ‘Medical Health Information System for Health Assessment, Weight Management and Meal Planning’, to go deeper into the behavioral aspects around managing poor nutritional behaviors.

An individual's physical environment, social environment and emotions play a significant role in driving nutritional decisions. NuPlanit is revolutionizing nutrition management by identifying the barriers and environmental triggers leading to destructive eating behaviors. The system helps modify the physical and social environment to bring about positive changes in behavior.

NuPlanit is a web and mobile solution that offers a holistic approach to improving nutrition by guiding healthy behaviors and helping the individual overcome the emotional and physical barriers that often inhibit progress. NuPlanit allows an individual to self-manage their nutrition and behaviors and find and connect to a care team (e.g. dietician, physician, health coach, etc.) to better coordinate care and ensure support, accountability and success. NuPlanit offers dietitians and healthcare professionals a software solution to more effectively manage client's care plans and progress and promote their practice through the NuPlanit clinical network

### SUMMARY OF THE INVENTION

Unidentified and unresolved environmental factors and barriers to change are a significant cause of eating disorders, obesity and weight struggles. An individual's physical and social environment often introduces a psychological trigger, the trigger causes anxiety to go up and when anxiety goes up a behavior is engaged in to ease anxiety. When a person uses food as a coping skill, often the behavior is a binge, purge or restriction of food.

Understanding the environmental-behavior connection is critical information for the care team helping an individual make changes. Simply telling an individual to follow a specific meal plan is not effective if the environmental barriers are not identified and addressed. In a care setting, healthcare professionals such as dietitians, therapists and clinicians often provide the patient with coping skills to help with managing anxiety so that destructive behaviors do not happen.

Many people do not understand the role of a dietitian in helping them to manage their nutrition and behaviors and how to select one that meets their needs and preferences. Dietitians and other nutritional experts lack a means to promote their practice and connect with individuals that could benefit from their expertise.

When a patient engages with a dietitian, they typically meet face-to-face for 60 minutes once per week or once every two weeks. The patient and the dietitian discuss nutrition education, goals, strategies, meals plans, etc. The patient typically leaves with a paper copy of a meal plan. In between visits, the patient is asked to track what they eat—typically on paper. The goal of most dietitians is to help their patients consume a balance of wholesome foods every day as well as establish regular eating patterns (meals, snacks, etc.). The challenge is that behaviors are very hard to change and since there is very little, if any, interaction between the patient and dietitian between visits, progress can be very slow. Slow or no progress can be extremely discouraging and a patient is more likely to stop treatment. It is difficult for a dietitian to know what barriers exist in the patient's life which may be inhibiting progress.

### BRIEF DESCRIPTION OF THE FIGURES

FIG. 1 shows a schematic.

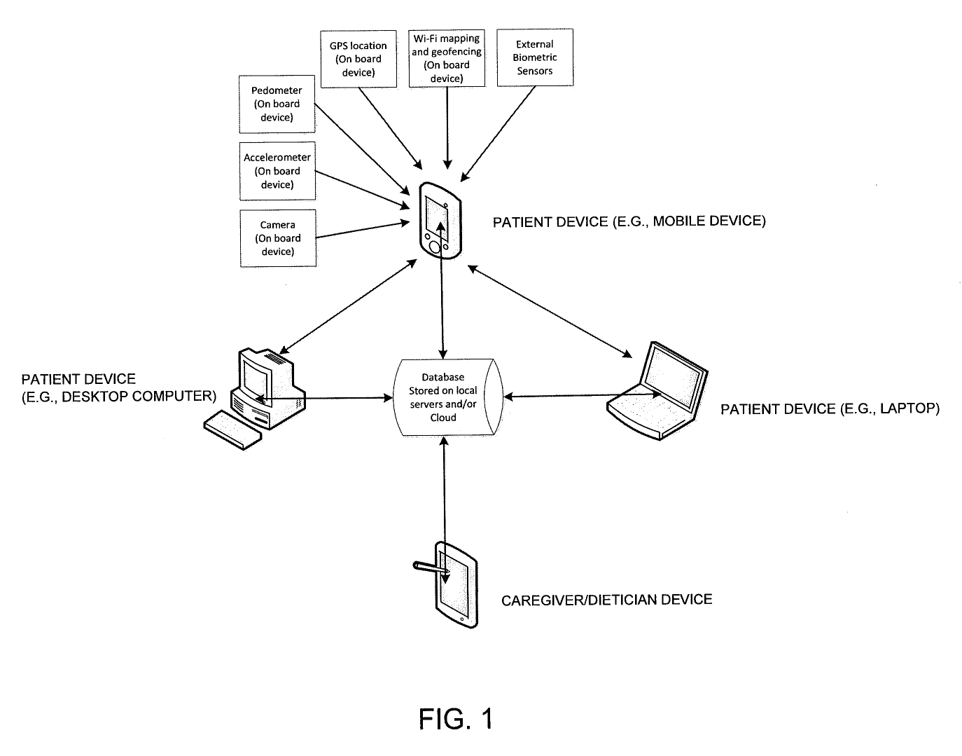

FIG. 2 shows a flowchart.

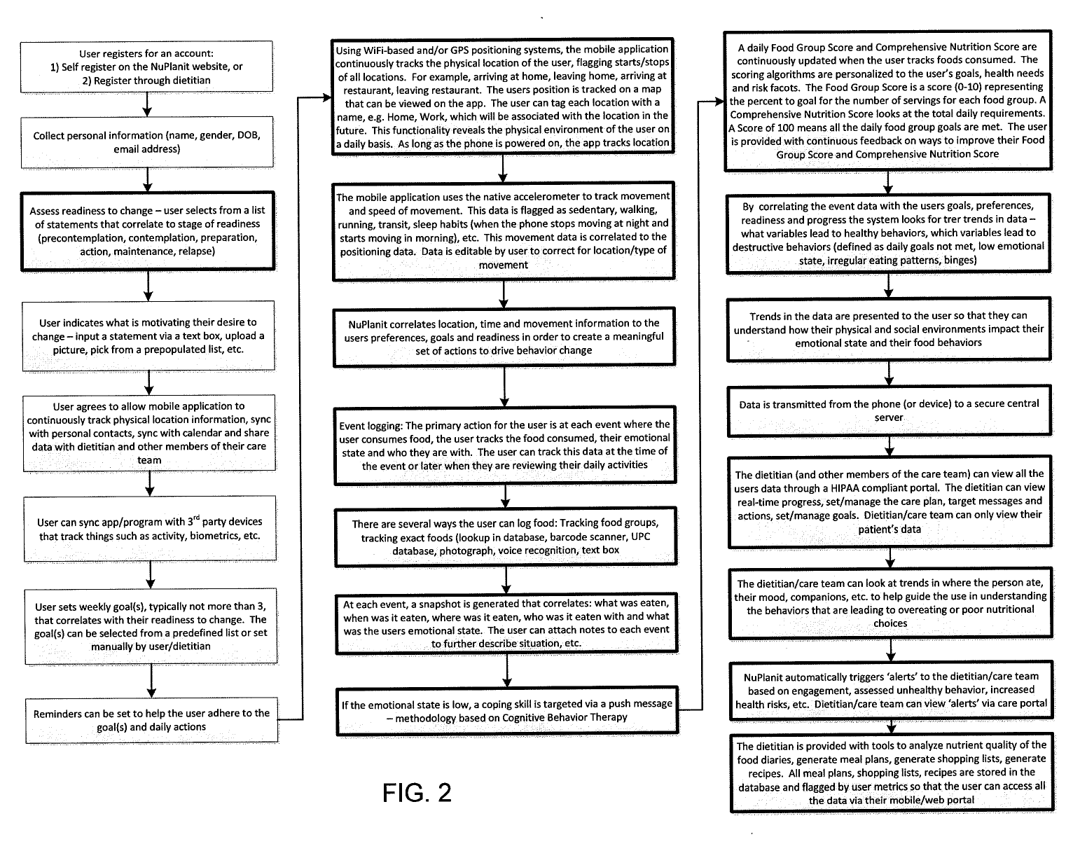

FIG. 3 shows a flowchart.

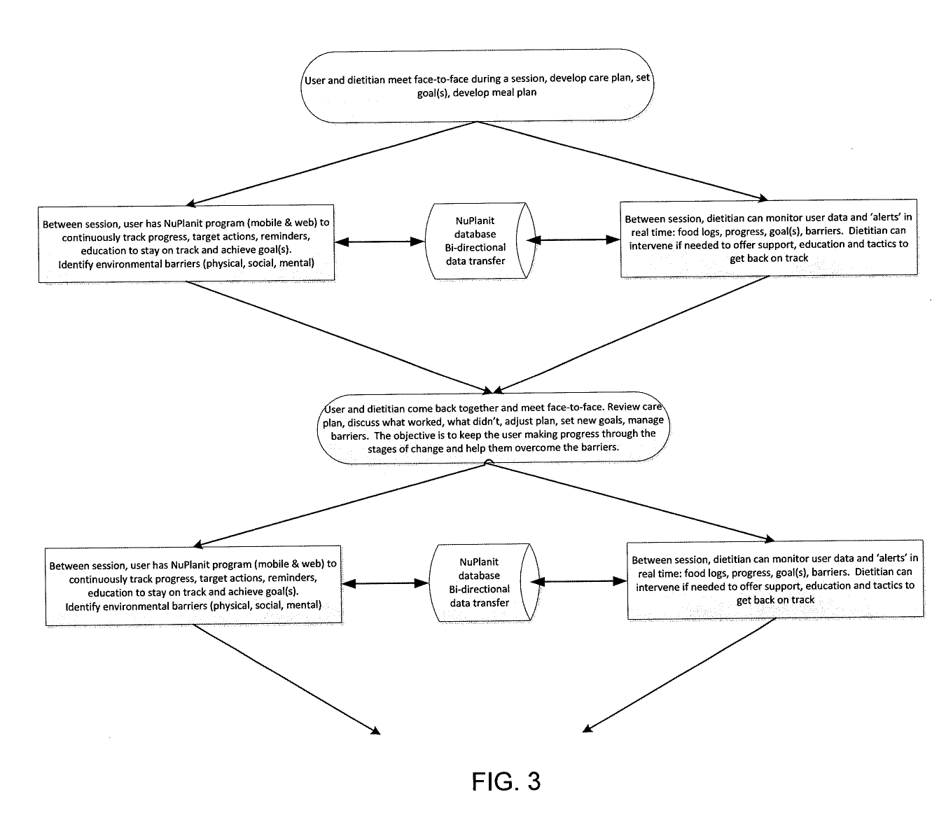

### DETAILED DESCRIPTION OF THE PREFERRED EMBODIMENTS

The Problem

Nutrition and diet is complex and individuals are struggling to find a solution that helps them achieve a sustainable path to reaching and maintaining a healthy relationship with food, a healthy weight and overall healthy lifestyle. Consumers are faced with a barrage of contradictory and misleading information regarding nutrition and diet. Each week there is a new silver bullet that will fix everything. There is no source for expert advice and people are desperate for answers. There are a number of factors that have not been addressed by the current solutions. Recognizing that these factors exist and providing solutions to deal with them is the key to success.

Today's nutrition and weight management programs fail to address the psychology of human behavior.

The primary reasons people have a hard time sticking with programs include:
a. The barriers keeping them “stuck” are not being addressed (physical/social environment, psychological state)
b. A person's readiness to change is not addressed
c. The proper level of support and accountability is missing

Unidentified and unresolved environmental factors and barriers to change are a significant cause of eating disorders, obesity and weight struggles

Dieting is destructive
a. Most people who “diet” regain their weight
b. Failed diets have a long-term psychological effect and make future success harder
c. Dieting and calorie counting can lead to obsessive and destructive behaviors

People do not understand the role of the dietitian and how to go about finding one that meets their preferences and needs. Dietitians lack the means to reach a broader audience and educate the public in order to attract more patients

Dietitians lack technology for education, nutrition management and progress tracking and lack a means to understand their patients' progress and issues between in-person sessions and target the right outreach at the right time.

### The Solution

For the individual (mobile & web):

Identify the physical, social and personal (emotional) barriers that are inhibiting healthy nutritional decisions

Determine the where, what, when, who, why, and emotion of an individual's food decisions:
a. Where: Real-time tracking of location via mobile device. Continuously monitor the physical location of the individual via GPS and/or Wi-Fi-based positioning system
b. What: Tracking foods eaten. The focus is on balance—making sure the individual eats the recommended amount of each food group daily. Different ways to log foods include: quick logging of food groups, photos of food eaten, UPC bar scanner, detail food logging from database, restaurant foods
c. When: Timestamp all physical locations and when meals/foods eaten and other data logged
d. Who: Track who the individual is with during the day, including who they ate meals with
e. Why: Track why the individual ate—hunger, craving, spontaneous, emotional
f. Emotion: Track the way the person feels emotionally. Sliding scale from depressed to ecstatic

Correlate all the above into an ongoing profile of the individuals food decisions to identify trends in what happens during the day to lead to healthy behaviors and what leads to unhealthy behaviors—identify barriers

Target specific messages and cues based on location, time of day, emotion and other collected data at the time, using the right channel (e.g. text message, push notification, phone call and other channels that may be appropriate)to help change the individuals response to the physical/social environment so that healthier behaviors result.

The system learns the individual's readiness to change, motivations, behaviors, preferences, environment, stressors and goals as well as the responses to prior messages, cues and notifications and adapts its messaging to help guide small changes to encourage healthy decisions

The system learns anxiety-producing situations and targets coping skill at the right time (cognitive behavior therapy)

The system promotes and educates the individual on the “healthy trends” based on the information it has collected about the individuals food decisions, there preferences and their responses to previous information provided.

The system promotes and educates the individual on the “destructive trends” based on the information it has collected about the individuals food decisions, there preferences and their responses to previous information provided

Based on information provided by the individual and collected by the system the system assesses the individuals readiness to change (precontemplation, contemplation, preparation, action, maintenance, relapse) and structures the plan to match the readiness level
a. Small goals, small actions

The system tracks all physical activity
a. Automatic via accelerometer on mobile device
b. Connect with devices

The system targets incentives based on location, preferences, goals, and responses to previous incentives, notifications and communications.

Real-time data sync with care team

Social connection (anonymous) to other users of the system

Access to online user forums, seminars, content channels, etc.

A “panic” button that can be pressed in times of heightened anxiety when more support is needed in real-time. The support can consist of a video chat with a dietitian, email or text message to a dietitian, friend, family, etc., call a dietitian, friend, family, display a message, play a song, show a video, etc. The user can select which method of help they prefer.

For the care team (web):

A comprehensive nutrition management solution that identifies the environmental and social barriers inhibiting progress and tracks client progress in real-time. All data collected on the user/patient side (as described above) can be shared with the dietitian/care management side of the system.

Real-time patient profile comprised of all data entered by the individual, care team or generated by the system.

Progress and outcomes tracking with automatic ‘alerts’ triggered by events or conditions

Food diary/nutrition analysis (food groups, calories, nutrients)

Nutrition Scoring providing a daily nutrition score as well as individual food items purchased at a retail grocery store or other food outlet.

Meal planning management
a. Generate meals, recipes and menus for patients
b. Share to patient web/mobile program

Shopping list and pantry management based on the individuals' specific preferences, health needs and responses to prior information provided.
a. Share to patient web/mobile program

Patient health assessment
a. Biometrics

Patient behavior assessment
a. Readiness, motivation, stressors, etc.

Goal setting/Action planning
a. Share to patient web/mobile program

Individuals' preferences for foods, locations (e.g. shopping, restaurants), preferred notification types and other information required to optimize the system, communications and general user experience of the individual.

Real-time intervention utilizing multiple channels (e.g. in app notification, text message, phone call, etc.) providing a message or cue optimized for the persons unique situation, including location, emotion, time of day and other data that optimize the impact of the intervention.

Targeted communication to promote education, events, etc. to users of system

On-call dietitian interface
a. Users/patients can contact dietitian (via an online interface, call-in number, etc.)
b. Dietitian can access patient profile
c. Dietitian can push specific and system generated notifications and cues to the individual selecting the appropriate channel and time to optimize the impact of the notification or cue

Social Communities for dietitians to interact and share information and content
a. Communities focused on various disciplines and areas of interest
b. Social connection with other dietitians and users/patients in network
c. Moderate user forums
d. Moderate a forum specific to their patent base or a selected subset of their patients
e. Provide individual and/or group video counseling and educational sessions to their patients and other users of the system.

NuPlanit will leverage the network of dietitians to provide online seminars, etc. that patients/users can subscribe to. This also serves as a way for dietitians to gain access to new patients.

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

It will be understood that each element of the illustrations, and combinations of elements in the illustrations, can be implemented by general and/or special purpose hardware-based systems that perform the specified functions or steps, or by combinations of general and/or special-purpose hardware and computer instructions.

These program instructions may be provided to a processor to produce a machine, such that the instructions that execute on the processor create means for implementing the functions specified in the illustrations. The computer program instructions may be executed by a processor to cause a series of operational steps to be performed by the processor to produce a computer-implemented process such that the instructions that execute on the processor provide steps for implementing the functions specified in the illustrations. Accordingly, the figures support combinations of means for performing the specified functions, combinations of steps for performing the specified functions, and program instruction means for performing the specified functions.

Although the present invention has been described with respect to a specific preferred embodiment thereof, various changes and modifications may be suggested to one skilled in the art and it is intended that the present invention encompass such changes and modifications as fall within the scope of the appended claims.

We claim:

1. A method comprising:
receiving data representing the physical location, movement, social environment, emotional state and nutritional behavior;
comparing this data and nutritional behaviors throughout the day to goals for achieving a balance of macronutrients (food groups) and micronutrients, represented by a Nutrition Score; Determining the positive and negative impact of physical and social environment on nutritional behaviors and emotional state;
targeting messages, cues, tips and coping tactics based on acquired parameters to help change the individuals response to the environment and other factors, improve mood, reduce anxiety and improve nutritional behavior;
allowing for real-time connectivity to a support system.

2. The method of claim 1, where the acquired parameters are transmitted to health care professionals, such as dietitians, therapists, physicians, health coaches, through real-time connectivity to acquired parameters, health professionals can more effectively coordinate and target care.
